(19) United States
(12) Patent Application Publication
(10) Pub. No.: US 2011/0153189 A1
(43) Pub. Date: Jun. 23, 2011

(54) HISTORICAL TRAFFIC DATA COMPRESSION

(75) Inventors: Chih-ming James Chiang, Chandler, AZ (US); Minan Miin-Nan Lee, Tempe, AZ (US); Kungwel Liu, Chandler, AZ (US); Susan S. Chen, Chandler, AZ (US); Merlin J. Smith, Chandler, AZ (US)

(73) Assignee: GARMIN LTD., Camana Bay (KY)

(21) Appl. No.: 12/640,679

(22) Filed: Dec. 17, 2009

(51) Int. Cl. G01C 21/36; G06F 17/30

(52) U.S. Cl. 701/201; 701/208; 701/209; 701/200; 701/204; 707/790; 707/E17.018

(57) ABSTRACT

A device and method for calculating information regarding a route to a destination. The device may include a computer-readable memory element on which is stored a plurality of templates comprising historical speed values for a quantity of time segments and a map database including data for a plurality of road segments associated with template codes identifying one or more of the templates. The device may also include a processing device for accessing the map database to determine a historical speed value for one or more selected road segments. The historical speed value may be used for calculating an estimated amount of time to complete a selected route, a route to the destination that takes the least amount of time, and/or a predicted time of arrival at the destination.

### BACKGROUND

Embodiments of the present invention relate to a device and method for calculating navigational route information using templates of historical speed values.

Navigation devices can estimate the time it will take to arrive at a desired destination based on variables such as distance to the destination, current speed, and/or anticipated speed over the remainder of the journey. Determining an anticipated speed over a portion of a journey can be difficult because traffic does not always move at a constant pace along all types of road segments and may be influenced by factors such as rush hour congestion, which can vary according to the time of day and day of the week. However, navigation devices can use historical traffic data trends to predict or anticipate probable speeds over the remainder of the journey and provide more accurate time of arrival estimates.

### SUMMARY

Embodiments of the present invention relate to a device and method for calculating information regarding a navigational route to a destination. The device may include a computer-readable memory element on which is stored a plurality of templates comprising historical speed values for a quantity of time segments and a map database including a plurality of road segments associated with template codes identifying one or more of the templates. The device may also include a processing device for accessing the map database to determine a historical speed value for one or more selected road segments. The historical speed value may be used for calculating an estimated amount of time to complete a selected route, a route to the destination that takes the least amount of time, and/or an estimated time of arrival at the destination. Instead of storing multiple historical speed values and time segments for each road segment into memory, the road segment may be associated with the corresponding template in memory. This allows a single template to be associated with a plurality of road segments so that memory space may be used efficiently.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of an analysis device constructed according to an embodiment of the present invention;

FIG. 2 is a perspective view of a portable electronic device constructed according to an embodiment of the present invention;

FIG. 3 is a schematic diagram of the portable electronic device of FIG. 2;

FIG. 4 is a schematic diagram of a Global Positioning System (GPS) that may be utilized by various embodiments of the present invention;

FIG. 5 is a flow chart of a method for storing historical traffic information according to an embodiment of the present invention;

FIG. 6 is a graph of an example template of time segments versus traffic speeds;

FIG. 7 is a graph of another example template of time segments versus traffic speeds;

FIG. 8 is a graph of exemplary recorded historical traffic data and a template that best corresponds with the historical traffic data;

FIG. 9 is another graph of exemplary recorded historical traffic data and a template that best corresponds with the historical traffic data;

FIG. 10 is yet another graph of exemplary recorded historical traffic data and a template that best corresponds with the historical traffic data;

FIG. 11 is a flow chart of a method for using historical traffic information stored in memory according to an embodiment of the present invention; and

FIG. 12 is a flow chart of a method for estimating an amount of travel time for a particular route.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

The present invention relates to a device, method, and computer program for efficiently storing traffic information corresponding to a plurality of road segments using a plurality of templates and calculating information regarding a navigational route to a destination using the templates. Storing and accessing historical traffic data may be helpful in predicting the speed of traffic at a particular time and/or day on a particular road segment for navigational or travel-time estimation purposes. Historical traffic data for each road segment may include historical speeds of traffic recorded, such as average speeds, nominal historical speeds generated from traffic recorded, speeds calculated during one or more time segments of a period of time, combinations thereof, and the like. A plurality of different templates comprising various historical speed values for each time segment during the period of time may be stored in memory. For a particular road segment, historical traffic speeds may be compared with speed values at corresponding time segments in the templates to determine a corresponding template which most closely mimics the historical traffic data of the road segment. Once the corresponding template is determined, the road segment is associated with the corresponding template in memory. This is particularly advantageous when the number of templates is smaller than the total number of road segments.

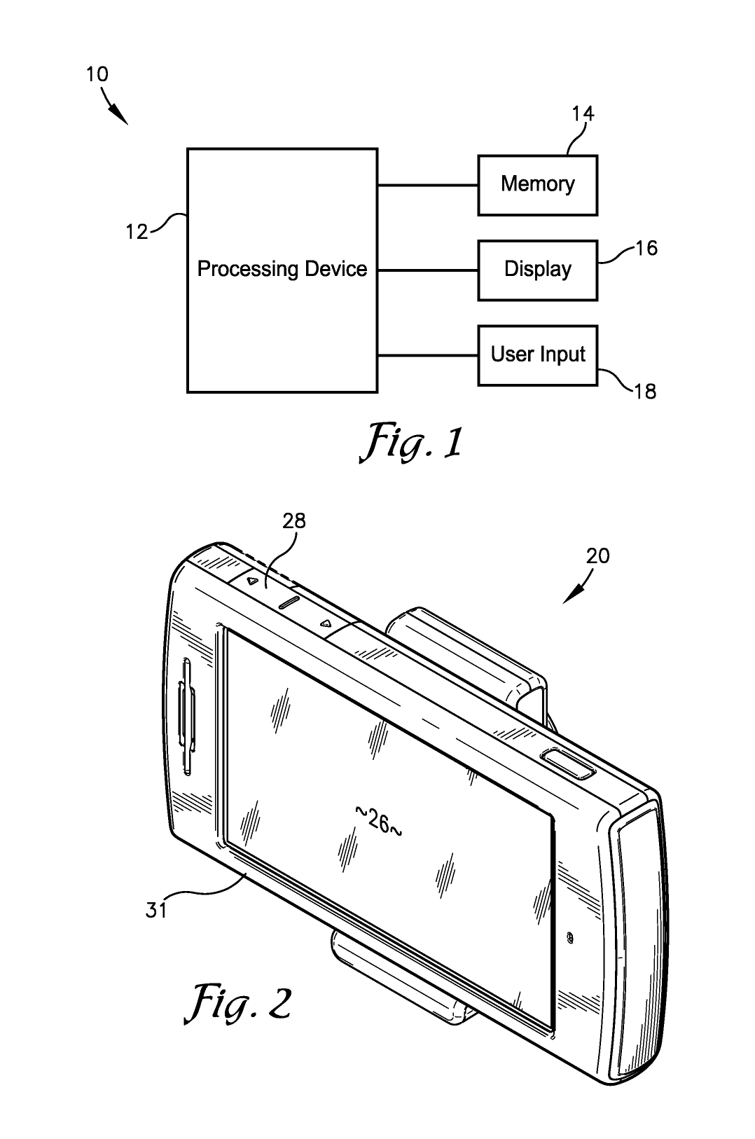

As illustrated in FIG. 1, an analysis device 10 that may be used to implement aspects of the present invention may comprise a processing device 12, a memory element 14, a display 16, and a user interface 18. The analysis device 10 may be used to collect historical traffic data and determine how the historical traffic data is stored. The analysis device 10 may transfer data stored onto the memory element 14 to a portable electronic device 20, such as the one shown in FIGS. 2-3, which may be configured to access the historical traffic data to determine navigational route information. Alternatively, the analysis device 10 may be the portable electronic device 20 and/or the analysis device 10 and the portable electronic device 20 may be integral with each other.

The processing device 12 may be configured for determining what information to store in the memory element 14 based on a statistical analysis of historical traffic data compared with stored templates. The processing device 12 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various components of the analysis device 10.

In various embodiments, the processing device 12 may implement a computer program and/or code segments to perform the functions described herein. The computer program may comprise a listing of executable instructions for implementing logical functions in the processing device 12. The computer program can be embodied in any computer readable medium for use by or in connection with an instruction execution system, apparatus, or device, and execute the instructions. In the context of this application, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semi conductor system, apparatus, device or propagation medium. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM), combinations thereof, and the like.

The memory element 14 may be integral with the processing device 12, stand alone memory, or a combination of both. The memory element 14 may include, for example, removable and non removable memory elements such as RAM, ROM, flash, magnetic, optical, USB memory devices, and/or other memory elements. The memory element 14 may store traffic templates, road segment information and indicators, historical traffic data, map databases, and the like, as well as the computer program and code segments mentioned above or other data for instructing the processing device 12 to perform the functions and methods described herein.

The display 16 may comprise a graphical interface operable to display visual graphics, images, text, etc. in response to external or internal processes and commands. In some embodiments, the display 16 may be operable to present a visual indication of at least a portion of a calculated route. The display 16 may comprise conventional black and white, monochrome, or color display elements including CRT, TFT, LCD, and/or LED display devices. The display 16 may be integrated with the user interface 18, such as in embodiments where the display 16 is a touch screen display to enable the user to interact with it by touching or pointing at display areas to provide information to the analysis device 10. The display 16 may be coupled with the processing device 12 and may be operable to display various information corresponding to the analysis device 10, such as templates, historical traffic data, route information, etc., as described below.

The user interface 18 enables one or more users to share information with the analysis device 10, such as historical traffic data, comparison rules and thresholds, starting points, intended destinations, route preferences, and the like. The user interface 18 may comprise one or more functionable inputs such as buttons, switches, scroll wheels, a touch screen associated with the display 16, voice recognition elements such as a microphone, pointing devices such as mice, touchpads, tracking balls, styluses, a camera such as a digital or film still or video camera, combinations thereof, etc. Further, the user interface 18 may comprise wired or wireless data transfer elements such as a removable memory, data transceivers, etc., to enable the user and other devices or parties to remotely interface with the analysis device 10. The user interface 18 may also include a speaker for providing audible instructions and feedback.

The portable electronic device 20, such as the one illustrated in FIGS. 2-3 and described in detail below, may access the memory element 14 and/or a resident memory 22, as described below. The portable electronic device 20 may be a mobile phone, portable navigation device, or any other device having location-determining capabilities, and may include GPS-based location and navigation programs and/or devices and the like. In a specific embodiment, the portable electronic device 20 may be a Nüvi® 1690 by Garmin Ltd. The resident memory 22 may include some or all templates, road segments, and map databases stored on the memory element 14 as described herein.

In one embodiment, the portable electronic device 20 may comprise a processing device 24, the resident memory 22, a display 26, a user interface 28, a location-determining element 30, and a portable handheld housing 31. The processing device 24, the resident memory 22, the display 26, and the user interface 28 may be similar or identical to the processing device 12, memory element 14, display 16, and user interface 18 of the analysis device 10. Alternatively, a single integrated device may be capable of performing the features of both the portable electronic device 20 and the analysis device 10, and may have a single processing device, memory, display, and user interface, as well as a location-determining element. The portable handheld housing 31 may be composed of any material and may be configured for retaining the processing device 24, the resident memory 22, the display 26, the user interface 28, and/or the location-determining element 30.

In various embodiments, the location-determining element 30 may be a global positioning system (GPS) receiver which provides current geographic location information for the portable electronic device 20. As an example, the location-determining element 30 may be a Global Position System (GPS) receiver and/or other satellite navigation receiver operable to receive signals from one or more orbiting satellites.

In general, the GPS is a satellite-based radio navigation system capable of determining continuous position, velocity, time, and direction information for an unlimited number of users. Formally known as NAVSTAR (Navigation Signal Timing and Ranging), the GPS incorporates a plurality of satellites which orbit the earth in extremely precise orbits. The GPS system is implemented when a device specially equipped to receive GPS data begins scanning radio frequencies for GPS satellite signals. The device may continue scanning for signals until it has acquired at least three different satellite signals. Implementing geometrical triangulation, the receiver may utilize the three known positions to determine its own two-dimensional position relative to the satellites. Acquiring a fourth satellite signal will allow the receiving device to calculate its three-dimensional position by the same geometrical calculation. The positioning and velocity data can be updated in real time on a continuous basis by an unlimited number of users.

Although GPS-enabled devices are often used to describe navigational devices, any receiver suitable for use with other global navigation satellite systems (GNSS) may be used instead of or in addition to the GPS receiver. It will also be appreciated that satellites need not be used to determine a geographic position of a receiving unit since any receiving device capable of receiving the location from at least three transmitting locations can perform basic triangulation calculations to determine the relative position of the receiving device with respect to the transmitting locations. For example, cellular towers or any customized transmitting radio frequency towers can be used instead of satellites. In some embodiments, a communications network associated with the device 20 may provide the device 20 with data indicating its location. In this way, personal hand held devices, mobile phones, intelligent appliances, intelligent apparel, and others can be readily located geographically, if appropriated equipped to be a receiving unit.

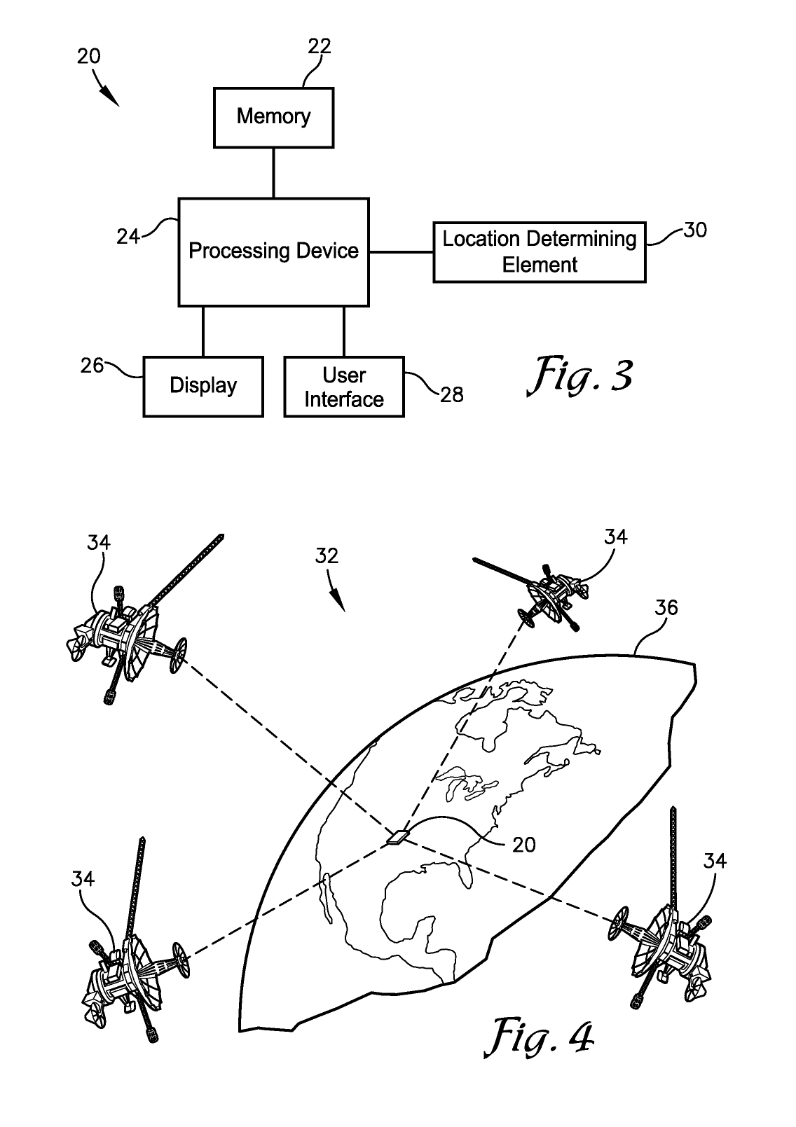

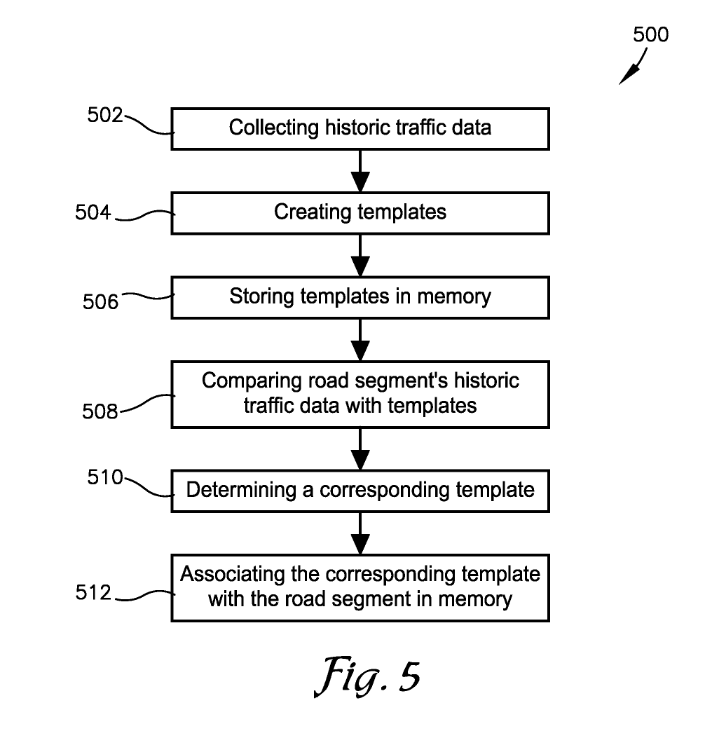

FIG. 4 shows one representative view of a GPS denoted generally by reference numeral 32. A plurality of satellites 34 are in orbit about the Earth 36. The orbit of each satellite is not necessarily synchronous with the orbits of other satellites and, in fact, is likely asynchronous. The portable electronic device 20 such as the ones described in connection with preferred embodiments of the present invention is shown receiving spread spectrum GPS satellite signals from the various satellites 34.

In various embodiments, the location-determining element 30 and processing device 24 are operable to receive navigational signals from the GPS satellites 34 and to calculate positions of the portable electronic device 20 as a function of the signals. The location-determining element 30 and computing processing device 24 may, for example, determine a track log or any other series of geographic coordinates corresponding to points along a path traveled by a user of the device. The location-determining element 30 and/or the processing device 24 are also operable to calculate a route to a desired location, provide instructions to navigate to the desired location, display maps and other information on the portable electronic device display 26, and to execute other functions described herein.

The location-determining element 30 may include one or more processors, controllers, or other computing devices and memory so that it may calculate location and other geographic information without the processing device 24 or it may utilize the components of the processing device 24. Further, the location-determining element 30 may be integral with the processing device 24 such that the location-determining element 30 may be operable to specifically perform the various functions described herein. Thus, the processing device 24 and location-determining element 30 can be combined or be separate or otherwise discrete elements.

In other embodiments, the location-determining element 30 need not directly determine the current geographic location of the portable electronic device 20. For instance, the location-determining element 30 may determine the current geographic location by receiving location information directly from the user, through a communications network, or from another electronic device.

The location-determining element 30 may include an antenna to assist in receiving the satellite signals. The antenna may be a patch antenna, a linear antenna, or any other type of antenna that can be used with navigational devices. The antenna may be mounted directly on or in the portable electronic device 20 or may be mounted external to the portable electronic device 20.

The above-described analysis device 10 and/or the portable electronic device 20 may be used to implement a method of selecting and storing historical traffic data in the memory element 14 using templates. The templates may represent a plurality of possible traffic data scenarios of historical traffic speeds per time segments during a period of time. By comparing actual (recorded) historical speeds for various time segments with each of the templates, the analysis device 10 may select a template that most closely represents the actual historical traffic data for a particular road segment. The road segment may be associated in memory with a corresponding template via template codes stored in a map database. The quantity of templates may be much smaller than the total number of road segments, saving space over a brute force method of storing each speed value for each time segment over the period of time for every road segment.

The flow chart of FIG. 5 depicts the steps of an exemplary method 500 of embodiments of the invention in more detail. In this regard, some of the blocks of the flow chart may represent a module segment or portion of code of the computer programs stored in or accessible by the processor. In some alternative implementations, the functions noted in the various blocks may occur out of the order depicted in FIG. 5. For example, two blocks shown in succession in FIG. 5 may in fact be executed substantially concurrently, or the blocks may sometimes be executed in the reverse order depending upon the functionality involved.

As illustrated in FIG. 5, the method 500 may comprise collecting historical traffic data (as depicted in step 502), creating templates (as depicted in step 504), storing templates into memory (as depicted in step 506), comparing historical traffic data to the templates (as depicted in step 508), determining a corresponding template (as depicted in step 510), and associating the corresponding template with the road segment in memory (as depicted in step 512).

In more detail, the collecting step 502 may comprise collecting speed and location information from a plurality of sources including but not limited to the portable electronic device 20, geographic location devices, speed sensors, GPS receivers/transceivers, radar, and satellite. The location information may be used to associate a particular road segment with the collected information, and the speed information collected may be averaged over one or more time segments. Additionally or alternatively, the collected speed information may be subjected to other statistical or empirical processing methods to extract the representative speed information such that embodiments of the present invention are not limited to the use of historical average speed information. The time segments may be any length or fraction of time within the period of time. The period of time may be a day, a week, a month, a year, or any multiples or fractions thereof, while the time segments may be intervals of seconds, minutes, hours, etc. Both speed and time data may be collected, tracked, or averaged at various levels of precision, depending on how much memory space is available and how many templates are used. The historical traffic data may also comprise speed information collected during multiple periods of time. For example, the historical traffic data for a time segment from noon to 12:15 pm on a Wednesday may include traffic speed information for that time segment collected each Wednesday for a month and then averaged together.

Various methods may be employed to collect the historical traffic data. For example, data may be collected and/or sent by GPS-enabled devices traveling on various road segments or cell phone signals may be analyzed using various methods to map traffic flow over various road segments. Historical traffic data may be obtained from a plurality of traffic databases, with each database collecting the traffic data using any variety of methods. Additionally or alternatively, historical traffic data may be compiled and weighted based on completeness or believed accuracy of the data. For example, more recently-obtained historical traffic data may be weighted more heavily than older historical traffic data.

Steps 504 and 506 comprise creating and then storing the plurality of templates into memory. Each template may be unique so that space in memory is efficiently used. Any quantity of templates may be created based on numerous factors such as typical speed limits (25 mph, 45 mph, 65 mph, etc), common traffic trends, historical traffic data for all of the road segments, statistical and empirical analysis of historical traffic data, and clustering schemes or algorithms. For example, if multiple road segments have similar historical speed values at corresponding time segments, a clustering scheme or algorithm may be applied to that historical traffic data to derive a template. The clustering scheme or algorithm may, for example, average speed values of each corresponding time segment for those related road segments to derive one of the templates to be placed into memory.

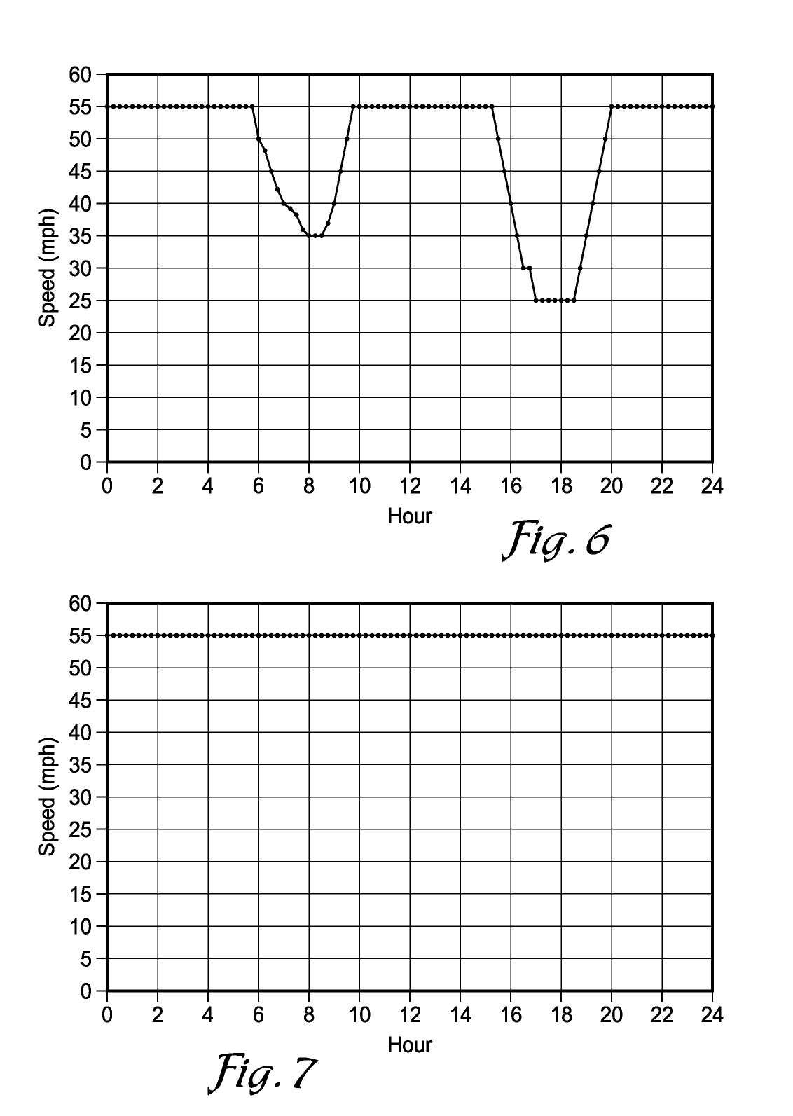

The templates may comprise a plurality of speed values for a plurality of time segments, as illustrated in the example template of FIG. 6. For example, FIG. 6 shows that during a time segment occurring at hour six, the average speed value for a corresponding road segment was 50 mph. Alternatively, polynomial curve fitting and/or Gaussian curve fitting of plotted template points may be used to provide additional compression for storage. Depending on the number of time segments included in each template, storing mathematical equations to define the time-speed relationship in the templates may use less space in memory than storing each time segment and its corresponding speed value.

Step 508 compares historical traffic data for one or more time segments with corresponding time segments of each of the templates. For example, various statistical data comparison methods, such as an adjusted R-square (R²) or Pearson product-moment correlation, may be used to determine an amount of correlation between the historical traffic data for one or more of the road segments and the templates. R² may be the square of a sample correlation coefficient between the historical traffic data and the templates. The Pearson product-moment correlation coefficient (PMCC) may be a measure of the correlation or linear dependence between two variables. However, any method of determining an amount of correlation between the historical traffic data and the templates may be used without departing from the scope of the invention.

These statistical analyses may be performed on speed values for each time segment or on speed values for each time segment for which speed values are available. For some road segments, there may be holes or gaps in the historical traffic data, such that the historical traffic data may not comprise information or speed values for each time segment. If not enough historical data is available for a particular road segment, an indication may be made in the memory element 14 that default settings should be used or followed for that road segment. For example, the default settings may also be stored in the memory element 14 as templates and/or otherwise accessed by the device. Default settings may be based on a classification of a particular road segment, such as a default speed of 65 mph for an interstate highway (class A) or a default speed of 10 mph for a non-paved road (class E).

If a road segment contains incomplete sample points, correlation can still be done on the points that are available with template profile points that match in time. If a particular road segment correlates with a substantial number of templates, then it is an indication that there is not enough information to accurately select from the templates and a default setting should be employed for the particular road segment. If the particular road segment matches with only a low number of templates, then one of the low number of templates can be accurately selected to determine historical speed information for the particular road segment. Thus, if a small number of template profiles are found to be good matches with the historical data, then the corresponding template may be selected from among the good matches, as in step 510, to be associated with the road segment. The analysis device 10 may be configured or programmed to select the corresponding template based on any number of preferences, thresholds, and rules. However, in some situations, only one template profile may be found to be a good match, in which case that template may be selected by the analysis device 10. Comparison values or correlation coefficients may be required to be within a predetermined range or meet a particular threshold to be considered a “good match” by the analysis device 10. The range or threshold may depend on user preference and/or which statistical comparison method is employed.

The template which is determined to most closely correlate with the historical data for a road segment is referred to herein as the corresponding template. The analysis device 10 may associate the road segment with the corresponding template in memory, as depicted in step 506. To associate a road segment with a template, the analysis device 10 may map the road segment to the corresponding template in memory, or may store a memory location of the corresponding template in a memory location associated with the road segment. For example, a map database may be stored in the memory and at least one of the road segments may be associated with a template code identifying at least one of the templates. Additionally, the memory location of the corresponding template may be used as the template code or a pointer, such that if traffic data regarding the road segment is requested, the address of the corresponding template may be read from memory and a computer program and/or the portable electronic device 20 may then access that memory location to retrieve the corresponding traffic data. Additionally or alternatively, the templates may be integrated or otherwise associated with the map database.

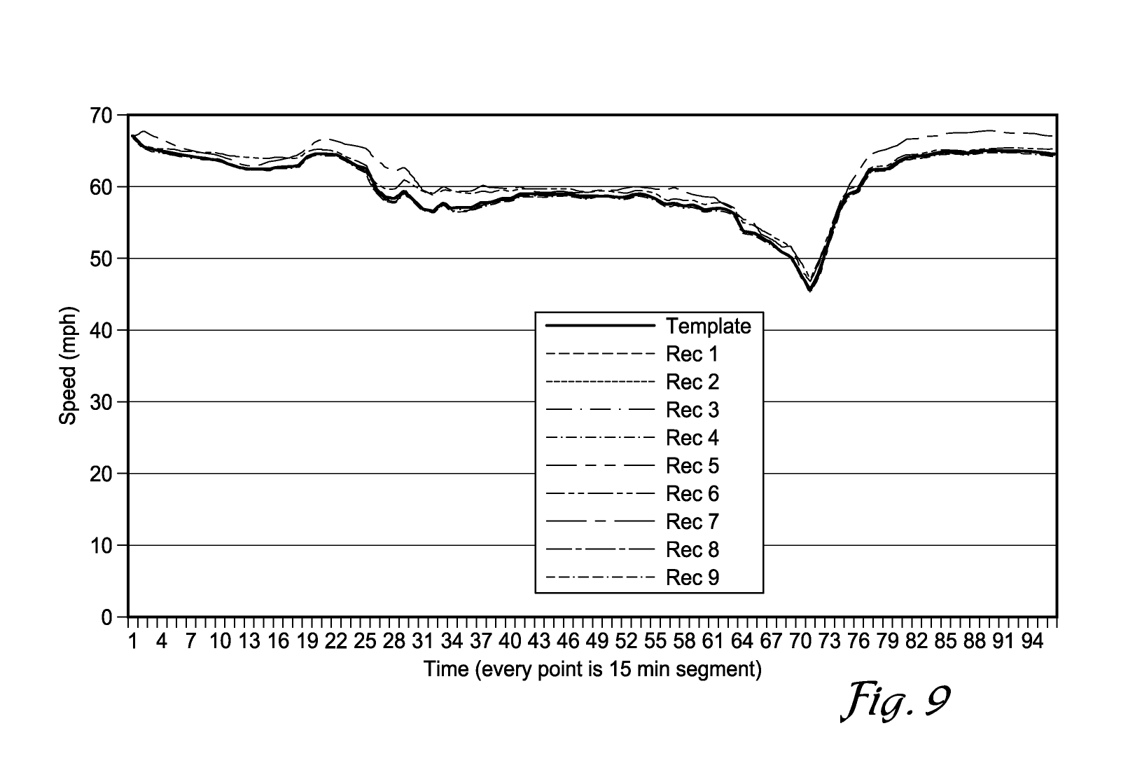

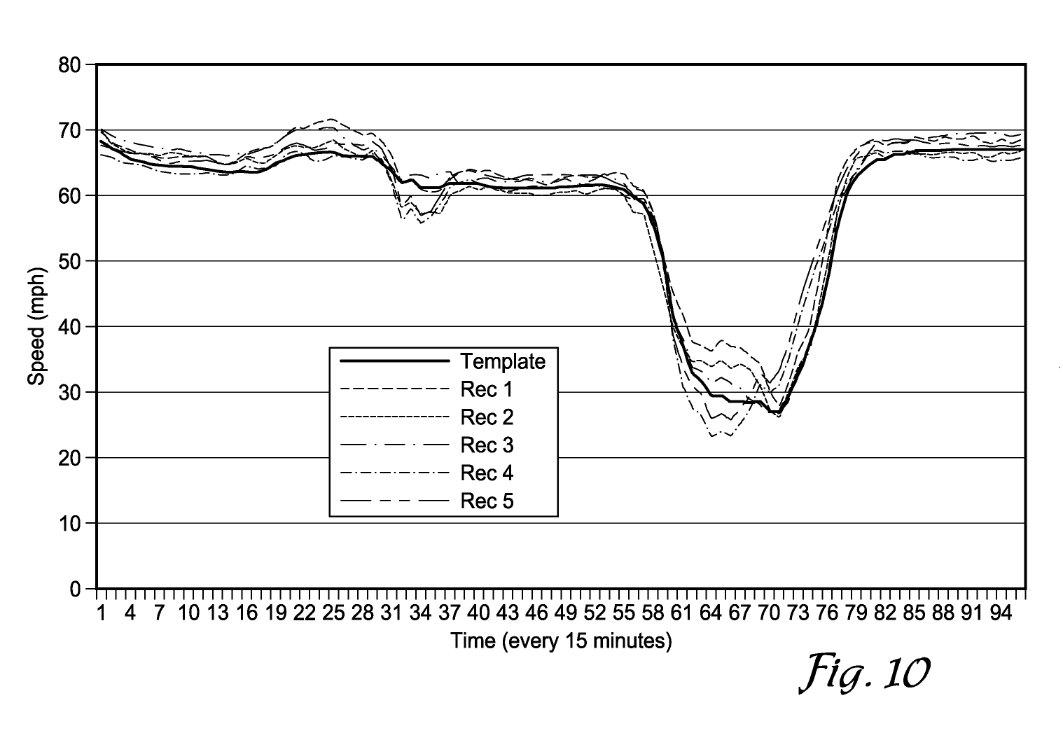

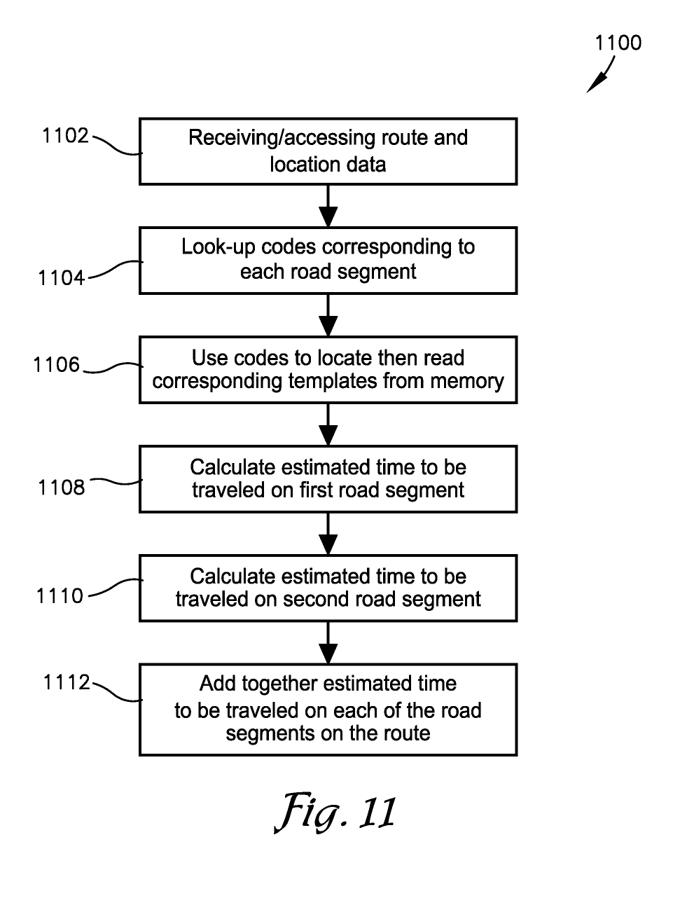

FIGS. 6-10 illustrate examples of the templates described above. For example, the template of FIGS. 6 and 7 each illustrate a 24 hour period of time with 96 time intervals, each 15 minutes in length. Each time interval of the example template in FIG. 7 is provided with the speed value of 55 miles per hour. Note that the template's time-speed content may be modeled in different ways. A simple non-parametric solution, as shown in FIGS. 6-7, provides raw speed data from 15 minute intervals. Other parametric methods such as polynomial curve fitting and/or Gaussian curve fitting can also be utilized, providing even greater reduction in the amount of memory required to store the traffic data. For example, the raw data template profile size would be 96 bytes (24×4×1 byte of speed data), while the Gaussian curves approach with two sets to provide two troughs might utilize only 6 bytes (3 bytes per Gaussian curve×2 troughs).

In one example, assuming a maximum set of 64 k templates, each template being 24 hours data with speed data every 15 minutes, the total number of bytes for all the templates would be 6 Mbytes (64 k×24×4×1 byte for speed) with non-parametric template profiles. The total number of bytes for all the templates might be less than 400 k with parametric modeling (64 k×6 bytes for Gaussian curve fitting). Each road segment may be mapped by a 2-byte code into the map database. For example, the memory element may store approximately 64,000 templates and one or more of the road segments of the map database may be associated with a two-byte code identifying one or more of the templates. The mapping of the road segments to the templates may use about 60 Mbytes, for example, if there are 30 million road segments×2 bytes for representing 64 k potential profiles. However, embodiments of the present invention may employ any number of templates each having any time resolution to indicate historical speed information. In some embodiments, the number of templates and/or the resolution of each template may be variable or otherwise configurable depending on the number of road segments, the traffic patterns on the road segments, the memory capacities of the portable electronic devices 20, combinations thereof, and/or the like.

The total memory used for storing the templates and associating road segments with particular templates in the example above is about 66 Mbytes (60 Mbytes for mapping+6 Mbytes to store the templates). This is a savings in memory space compared to a potential of 20.2 Gbytes required by a brute force method of storing a speed value every 15 minutes for a whole week with 30 million road segments (30 million×24×4×7×1 byte for speed).

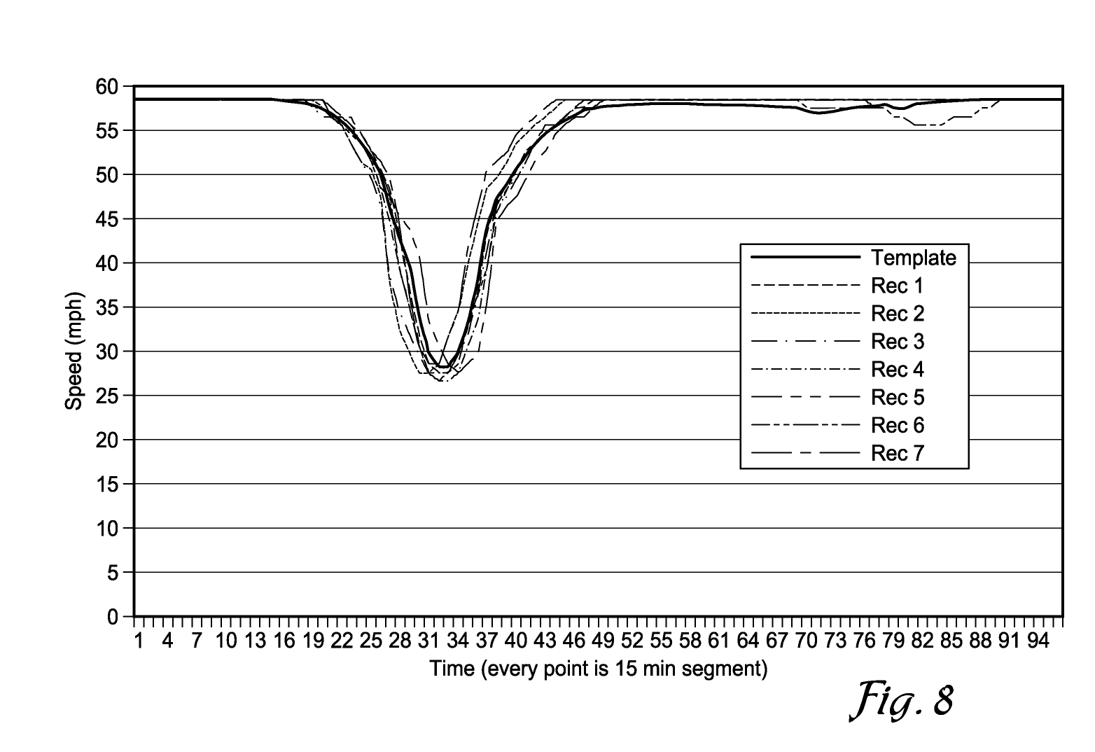

Each of FIGS. 8-10 illustrates a plurality of recorded historical traffic data (labeled “Rec”) for a particular road segment. Based on statistical analysis and/or comparison of the recorded historical traffic data, the analysis device 10 may determine which template best represents the recorded historical traffic data. As can be seen in FIGS. 8-10, the corresponding template (labeled “Template”) selected may closely match the speed at each time segment of the recorded historical traffic data.

The templates and map database information stored in the memory element 14 by the analysis device 10 may be duplicated in the resident memory 22 or otherwise made accessible by the portable electronic device 20, such as through a communications or data network, and may be accessible by software programs stored on the portable electronic device 20 for calculating a route and/or predicting an amount of time a journey to a particular destination may take. As updated historical traffic data becomes available, the analysis device 10 may be utilized to compare the updated historical traffic data with the templates and reassign various road segments to different templates as required. As mentioned above, a single integrated device may be capable of performing the features of both the portable electronic device 20 and the analysis device 10.

The above-described portable electronic device 20 may be used to implement a method of retrieving historical traffic data using the map database to estimate an amount of travel time to a particular location. The device 20 may also be used to calculate the quickest estimated route to the particular location or destination. The processing device 24 may receive navigation instructions and/or route information from the user interface 28 and/or the resident memory 22 and current geographic location information from the location-determining element 30. Based on road segments selected by the processing device 24 or a user, the processing device 24 may access the map database to determine which templates correspond with each of the road segments. In some embodiments, selection of road segments by the processing device 24 may including checking if a selected road segment can be part of the route calculation. Next, the processing device 24 may estimate an amount of time that will be spent on a first road segment of the trip based on the first road segment's template, a starting time segment of the trip, and a distance on the first road segment to be traveled. If the route requires travel on more than one road segment, based on the amount of time spent on the first road segment, the processing device 24 may determine a second time segment at which a second road segment adjacent to the first road segment will be reached to determine the amount of time that will be spent on the second road segment, and so on for each successive road segment included in the route.

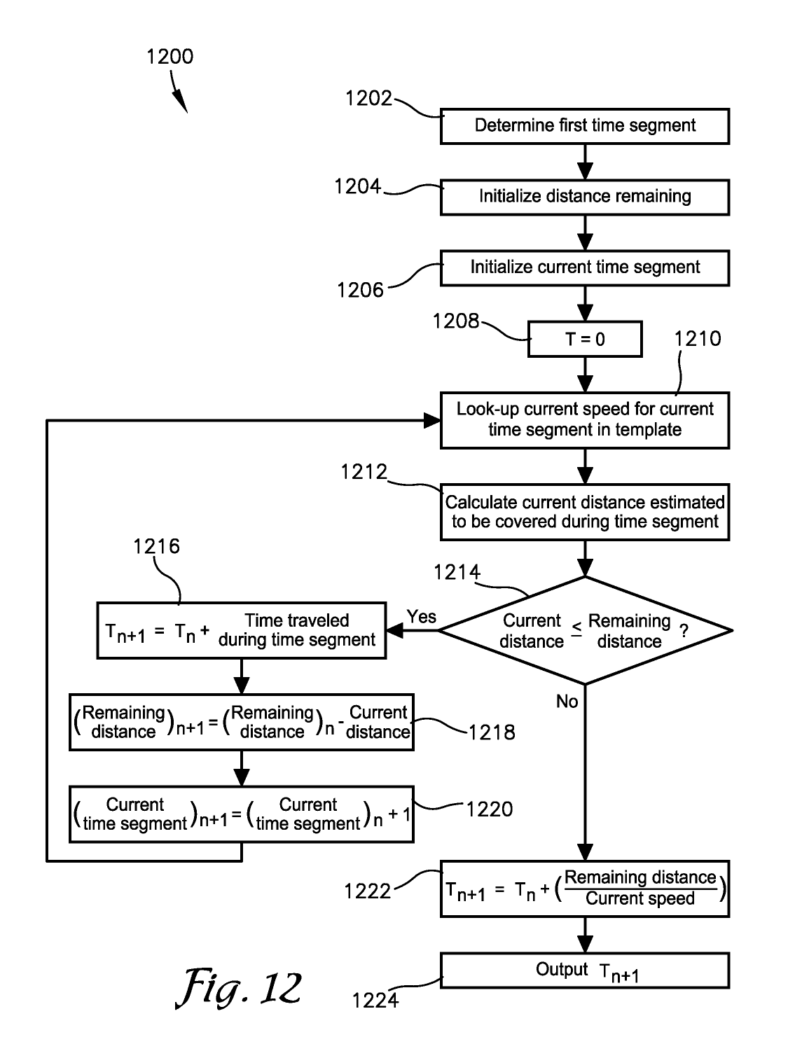

The flow charts of FIGS. 11 and 12 depict the steps of other exemplary methods of the invention in more detail. In this regard, some of the blocks of the flow charts may represent a module segment or portion of code of the computer programs stored in or accessible by the processing device. In some alternative implementations, the functions noted in the various blocks may occur out of the orders depicted in FIGS. 11 and 12. For example, two blocks shown in succession in FIG. 11 or 12 may in fact be executed substantially concurrently, or the blocks may sometimes be executed in the reverse order depending upon the functionality involved.

FIG. 11 illustrates a method 1100 for predicting travel time to a destination. The method may comprise receiving and/or accessing navigation instructions and route information, such as from the user interface 28 and/or the resident memory 22, and current geographic location information, such as from the location-determining element 30, as depicted in step 1102. The route information may include a starting location, an ending location, a starting time, road segments, distances, and any other relevant route information. The route information may be selected or input by a user and/or determined based on user inputs, or the processing device 24 may select the road segment based on the current geographic location of the portable electronic device 20. For example, the processing device 24 may select one or more road segments as part of a route calculation and/or the user may select one or more road segments, such as a starting location and a destination, to use as part of the route calculation

Next, based on the road segments selected or included in the route, the map database may be accessed to identify corresponding template codes associated with the selected road segments, as depicted in step 1104. The template codes may be used to determine which templates correspond with each of the road segments selected or included in the route. For example, a first road segment of the route may correspond with a first template, a second road segment of the route may correspond with a second template, and so on. However, some road segments may be similar enough that they correspond with identical templates. For example, the first road segment and the second road segment may have similar enough historical traffic data that they are both assigned the same template code in the map database. Thus, the first template and the second template as referenced herein may be the same template. Using the template codes, corresponding templates may be located and read from memory, as depicted in step 1106, to determine a historical speed value for the selected road segment. The historical speed value may be based on one or more time segments during which the selected segment is expected to be traveled.

Next, an estimated travel time for the selected road segment(s) based on the historical speed value may be calculated, as depicted in step 1108. For example an amount of time expected to be spent on the first road segment may be calculated. The amount of time spent on the first road segment may be based on the historical speed value stored in the first template corresponding with a first time segment and the distance to be traveled on the first road segment. The first time segment may coincide with a current time and/or a departure time.

FIG. 12 illustrates a method 1200 to determine an amount of time to travel from a first location to a second location. If a route from the first location to the second location only requires travel on the first road segment, then the first time segment corresponding with the current time may first be determined, as depicted in step 1202. A distance remaining may be initially set equal to the total distance between the first and second locations, as depicted in step 1204. Furthermore, a current time segment may be set equal to the first time segment, as depicted in step 1206. Additionally, a variable T may be set to zero 1208.

Next, a current speed corresponding with the current time segment may be looked up in the first template, as depicted in step 1210. Then a current distance that will be covered during the current time segment assuming travel at the current speed may be calculated, as depicted in step 1212. For example, if the time segment is 15 minutes, and the speed is 4 miles an hour, then 1 mile will be covered during the current time segment.

Then step 1214 may determine if the current distance is less than or equal to the remaining distances. If yes, then steps 1216-1220 may be performed, as follows. The amount of time traveled during the time segment may be added to the variable T, as depicted in step 1216. The current distance may be subtracted from the remaining distance to the second location, as depicted in step 1218. Then the current time segment may be increased by one to equal the next time segment, as depicted in step 1220. Steps 1210-1220 may then be repeated until the current distance is no longer greater than the remaining distance.

If the current distance is greater than the remaining distance to the second location, the remaining distance may be divided by the current speed then added to the current value of variable T to update T, as in step 1222. Then T may be output as the amount of time to get from the first location to the second location, as depicted in step 1224. The output may be visually or audibly output to a user, stored into a memory, transmitted to another electrical device, and/or otherwise used by the processing device 24. For example, the amount of time to get from the first location to the second location may be added to the starting time to determine a time of arrival.

If the route requires travel on more than one road segment, a second time segment corresponding with a time at which the second road segment adjacent to the first road segment will be reached may be determined (as depicted in step 1108) based on the amount of time spent on the first road segment. So, for example, if the second location in the embodiment of FIG. 12 is equal to the point at which the first road segment meets with the second road segment, the starting time plus output T (time from the first location to the second location) may determine a time corresponding with the second time segment. Based on the speed at the second time segment of the second template and the distance to be traveled on the second road segment, the amount of time that will be spent on the second road segment may be determined step 1110. Note that the method 1200 illustrated in FIG. 12 may be used for each of a plurality of road segments, with the output T calculated for each road segment being added with the previous road segments to estimate a total amount of travel time to complete the route (as depicted in step 1112). Furthermore, the total amount of travel time to complete the route may be continually updated based on a current geographic location received from the location-determining element 30. For example, in method 1200, the first location may be the current geographic location. Additionally, an estimated time of arrival at the destination may be determined based on the selected road segments of the route, one or more historical speed values, a departure time, and/or the estimated total amount of travel time required to complete the route. A visual indication of the estimated time of arrival may be presented on the display of the device 20.

A route to a destination may be calculated based on the current geographic location of the portable electronic device 20 and the determined historical speed value. Using one or more of the method steps described above, the processing device 24 may calculate and compare a plurality of possible routes to a destination to determine which route will take the least amount of time to travel, based on the historical traffic data and/or other data. For example, the processing device 24 may calculate a route at a particular time of day which is not the shortest route to the destination, but is the quicker route because it avoids a road segment that has a low historical speed value at that particular time of day due to traffic congestion. The display 26 may present a visual indication of at least a portion of the calculated route on the display of the device 20. For instance, the device 20 may present a moving map indicating its current position and surrounding road networks and indicate on the moving map appropriate portions of the moving map.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An electronic device comprising:
a computer-readable memory element on which is stored:
a plurality of templates each comprising historical speed values for a quantity of time segments, and
a map database including data for a plurality of road segments, at least one of the road segments being associated with a template code identifying at least one of the templates; and
a processing device communicably coupled with the computer-readable memory element and configured for:
accessing the map database to identify the template code associated with a selected one of the road segments;
selecting a template from the plurality of templates based on the identified template code, and
determining a historical speed value for the selected road segment using the selected template.

2. The electronic device of claim 1, wherein the historical speed value is also based on at least one time segment during which the selected segment is expected to be traveled.

3. The electronic device of claim 1, wherein the processing device is further configured for calculating estimated travel time for the selected road segment based on the historical speed value.

4. The electronic device of claim 1, wherein the time segments are each approximately 15 minutes long.

5. The electronic device of claim 1, wherein the memory element stores approximately 64,000 templates and one or more of the road segments of the map database are associated with a two-byte code identifying one or more of the templates.

6. The electronic device of claim 1, further comprising a location-determining element configured for providing a current geographic location of the electronic device to the processing device, wherein the processing device is configured for selecting the selected road segment based on the current geographic location of the electronic device.

7. The electronic device of claim 6, wherein the processing device checks if the selected road segment can be part of a route calculation.

8. The electronic device of claim 7, wherein the processing device is further configured for calculating a route to a destination based on the current geographic location of the electronic device and the determined historical speed value.

9. The electronic device of claim 8, further including a display for presenting a visual indication of at least a portion of the calculated route.

10. The electronic device of claim 8, wherein the processing device is further configured for determining an estimated time of arrival at the destination based on the determined historical speed value.

11. The electronic device of claim 1, further including a portable handheld housing for retaining the computer-readable medium and the processing device.

12. The electronic device of claim 1, wherein the templates are associated with the map database.

13. An electronic device comprising:
a display;
a location-determining element configured for providing a current geographic location of the electronic device;
a computer-readable memory element on which is stored:
a plurality of templates each comprising historical speed values for a quantity of time segments; and
a map database including data for a plurality of road segments, at least one of the road segments being associated with a template code identifying at least one of the templates;
a processing device communicably coupled with the display, the location-determining element, and the computer-readable memory element, the processing device configured for:
accessing the map database to identify the template code associated with a selected one of the road segments;
selecting a template from the plurality of templates based on the identified template code,
determining a historical speed value for the selected road segment using the selected template;
calculating a route from the current geographic location of the electronic device to a destination using the determined historical speed value; and
controlling the display to present a visual indication of at least a portion of the calculated route.

14. The electronic device of claim 13, wherein the processing device is further configured for calculating estimated travel time on the selected road segment based on the determined historical speed value.

15. The electronic device of claim 13, wherein the memory element stores approximately 64,000 templates and one or more of the road segments of the map database are associated with a two-byte code identifying one or more of the templates.

16. The electronic device of claim 13, further including a portable handheld housing for retaining the display, the location determining element, the computer-readable medium, and the processing device.

17. The electronic device of claim 13, wherein the processing device is further configured for determining an estimated time of arrival at the destination based on the determined historical speed values and controlling the display to present a visual indication of the estimated time of arrival.

18. The electronic device of claim 13, wherein the templates are associated with the map database.

19. The electronic device of claim 13, wherein the processing device is configured for:
identifying template codes for a set of the plurality of road segments,
selecting templates based on each of the identified template codes,
determining historical speed values for each road segment within the set, and
calculating the route to the destination using the determined historical speed values.

20. The electronic device of claim 13, wherein the processing device is configured for selecting the selected road segment based on the current geographic location of the electronic device.

21. A route calculation method comprising:
accessing an electronic map database stored in a computer-readable memory to identify a template code associated with a road segment;
selecting a template from a plurality of templates based on the identified template code, each of the templates comprising historical speed values for a quantity of time segments;
determining a historical speed value for the road segment using the selected template;
calculating a route to a destination using the determined historical speed value; and
presenting a visual indication of at least a portion of the calculated route on an electronic display.

22. The method of claim 21, further including calculating an estimated time of arrival at the destination using the determined historical speed value.

23. The method of claim 21, further including identifying template codes for a plurality of road segments, selecting templates based on each of the identified template codes, determining historical speed values for each of the road segments, and calculating the route to the destination using the determined historical speed values.

24. The method of claim 21, further including receiving a plurality of satellite signals to determine a current geographic location and calculating the route to the destination based on the current geographic location and the determined historical speed value.
